(19) United States
(12) Patent Application Publication
(10) Pub. No.: US 2023/0037122 A1
(43) Pub. Date: Feb. 2, 2023

(54) FIRE RETARDANT CUSPATED SHEET

(71) Applicant: American Wick Drain Corporation, Monroe, NC (US)

(72) Inventor: Warren Gregory HAMER, Matthews, NC (US)

(21) Appl. No.: 17/874,684

(22) Filed: Jul. 27, 2022

Related U.S. Application Data
(60) Provisional application No. 63/227,631, filed on Jul. 30, 2021.

(51) Int. Cl. E04C 2/22; A62C 3/02; E04C 2/06; E04C 2/32

(52) U.S. Cl. CPC E04C 2/22; A62C 3/0221; A62C 3/0214; E04C 2/06; E04C 2/32

(57) ABSTRACT

A sheet for providing an air gap is provided. The sheet includes a body defining a first surface. The sheet also includes cusps. The cusps extend from the first surface of the body, and one or more channels are formed between the cusps. The sheet includes fire-resistant material. This fire-resistant material may be fiberglass, talc, calcium carbonate, powdered metal, or another material(s). The one or more channels may be configured to permit liquid water, air, and/or other fluids to flow through.

### CROSS-REFERENCE TO RELATED APPLICATIONS

This application claims the benefit of U.S. Provisional Patent Application No. 63/227,631, filed on Jul. 30, 2021, and entitled “Fire Retardant Cuspated Sheet.” The entire contents of the aforementioned application are hereby incorporated herein by reference in its entirety for all purposes.

### FIELD OF THE INVENTION

The present invention relates to a fire retardant sheet that maintains a gap for air and/or other fluids.

### BACKGROUND OF THE INVENTION

Tunnel and walkway finishes have taken numerous forms for many years. Modern tunnel and walkway finishes are often required to be aesthetically pleasing. However, these items must do more than simply present the raw wall or ceiling face (e.g., concrete or stone) as modern tunnel and walkway finishes are required to serve multiple benefits as part of a larger system. Ease of maintenance, provision of an air gap, or water control and management are often requirements of the tunnel or walkway finish. Also, tunnels and walkways are often confined spaces, and these confined spaces, which are often packed with machinery and people, need a finishing solution that will not spread or contribute smoke or heat in the event of a fire.

Previously, others have attempted to use pre-fabricated panels to provide a finish, or as a fire resistant material. However, these rigid panels are heavy and difficult for individuals to install or replace. Contributing to additional labor or downtime. Foams and mesh products have also been utilized, but these products also have undesirable features. These products compress easily, making it difficult to maintain a gap for air, water, and other fluids.

In residential or commercial building applications, mold can form behind wall cladding, flooring, and roofing that is not properly ventilated. Furring strips are typically used to create an air gap. However, installation of cladding over furring strips can cause cladding bow and warp resulting in additional problems. Wood used as furring strips is typically not fire rated and may not be used in building construction in or near wildfire zones, depending on the local code.

Thus, there is a need for an alternative solution that overcomes these disadvantages.

### SUMMARY OF THE INVENTION

The present invention relates to a fire retardant sheet that maintains a gap for air and/or other fluids. In many embodiments, a thin, flexible, cuspated sheet is provided. The cuspated sheet includes a series of cusps arranged in a geometric pattern. The cusps may be designed and arranged so that they have a high compressive strength while also allowing liquid water, air, and/or other fluids to flow easily. The sheet may also limit the transmission of water vapor through a surface.

The sheet may comprise a low-cost, commodity thermoplastic with a fire resistant (FR) additive(s). The fire resistant additives may be non-halogenated, and the FR additives may char and snuff out combustible gases instead of contributing to the fire. The sheet may also comprise lightweight material, making it easy to install without heavy equipment. This lightweight sheet may help save labor and transportation costs.

In an example embodiment, a sheet for providing an air gap is provided. The sheet comprises a body defining a first surface and cusps. The cusps extend from the first surface of the body, and one or more channels are formed between the cusps. The sheet also comprises fire-resistant material. The channel(s) may be configured to permit liquid water, air, and/or other fluids to flow through.

In some embodiments, the sheet may include at least one of fiberglass, talc, powdered metal, calcium carbonate, or another material(s). The sheet may also include a thermoplastic material, and it may be formed, for example, through thermoforming, injection molding, or vacuum forming.

In some embodiments, the sheet may be configured to be placed between two layers, and the sheet may be configured to reduce the amount of deformation in the shape of the two layers. Cusps may be provided in a pattern, and, in some embodiments, the cusps are configured to provide support to the two layers at regular intervals. For example, the cusps may be provided to form a grid pattern.

In some embodiments, the cusps have a compressive strength of over 5,200 pounds per square foot. The sheet itself may weigh 0.2 pounds per square foot or less. Additionally, the material thickness of cusps may be greater than or equal to the material thickness of the body in some embodiments. Cusps may also be provided with at least one of a fillet or a chamfer.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1A illustrates a perspective view of an example sheet where a front surface may be seen in accordance with an embodiment of the present invention.

FIG. 1B illustrates a front view of the sheet of FIG. 1A.

FIG. 1C illustrates a perspective view of the sheet of FIG. 1A where a rear surface may be seen.

FIG. 1D illustrates a cross-sectional view of the sheet of FIG. 1A about the line A-A of FIG. 1B.

FIG. 2 illustrates a perspective view of another example sheet in accordance with an embodiment of the present invention.

FIG. 3 illustrates a schematic view of an example system with a sheet maintaining a gap between two layers in accordance with an embodiment of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

In various embodiments, sheets may be provided that may assist in maintaining a gap between two different layers. These layers may be walls, exterior cladding systems, flooring layers, hardwood, ceiling, or roofing material, etc. The sheets may include cusps to assist in maintaining this gap, and the cusps may be configured to have a high compressive strength. By maintaining a gap, the sheet may permit air, water, and other fluids to flow through the gap. Additionally, the sheets may beneficially include fire resistant material.

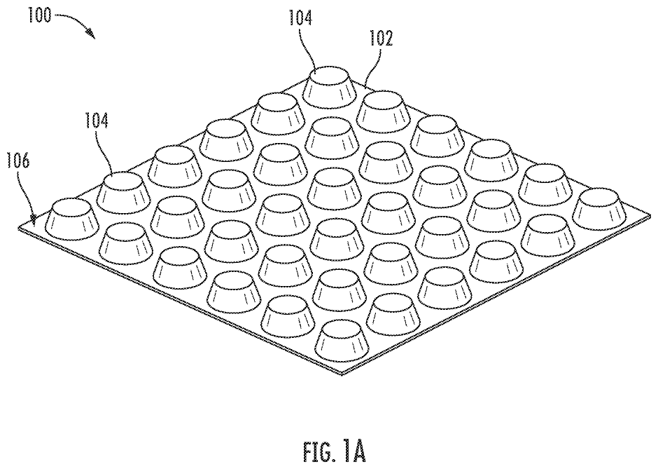

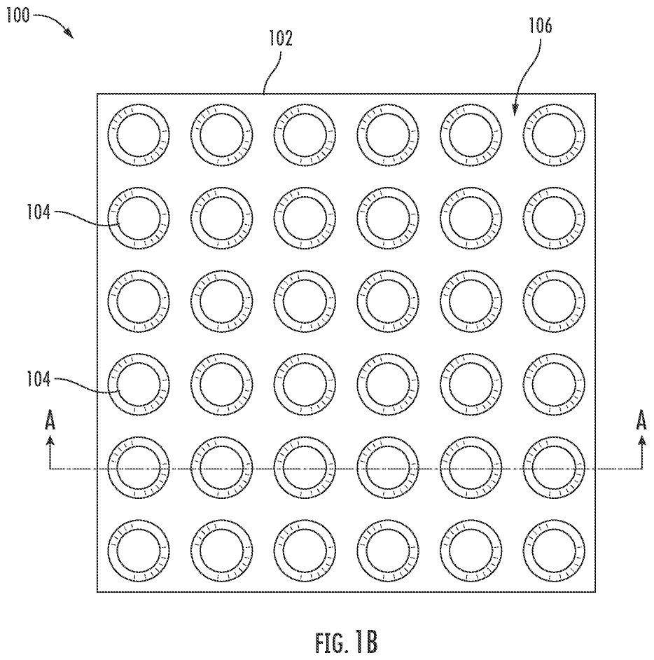

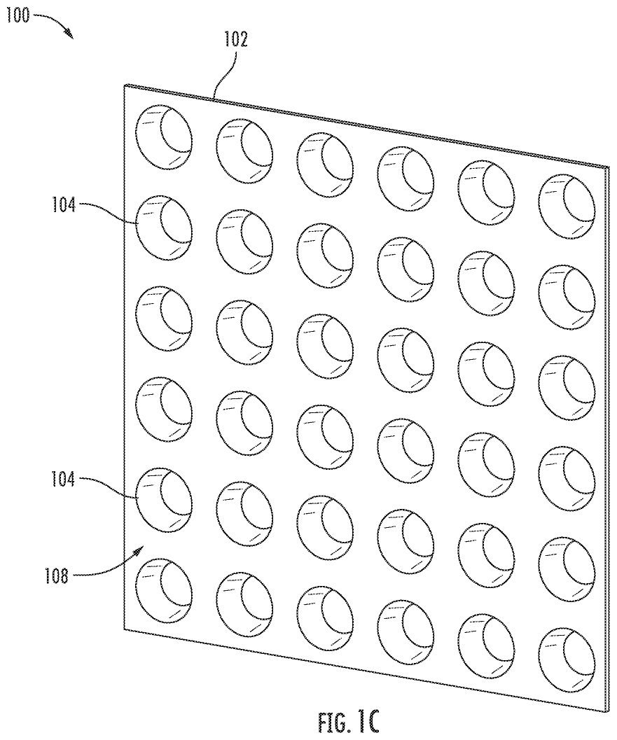

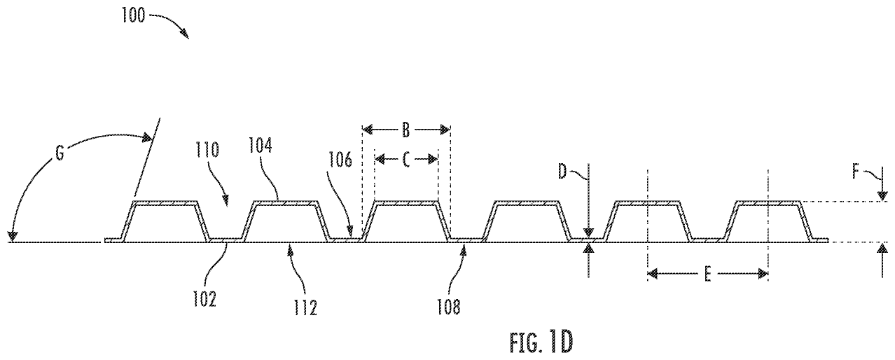

FIGS. 1A-1D illustrate an example sheet from a variety of different viewpoints. FIG. 1A illustrates a perspective view of an example sheet where a front surface may be seen in accordance with an embodiment of the present invention. FIG. 1B illustrates a front view of the sheet of FIG. 1A, and FIG. 1C illustrates a perspective view of the sheet of FIG. 1A where a rear surface may be seen. Finally, FIG. 1D illustrates a cross-sectional view of the sheet of FIG. 1A about the line A-A of FIG. 1B.

Looking first at FIG. 1A, a sheet 100 is illustrated. The sheet 100 may be made of flexible material with a relatively high compressive strength. In some embodiments, the sheet 100 may comprise a low-cost, commodity thermoplastic. A fire resistant additive(s) may also be included within the materials of the sheet 100. In some embodiments, fire resistant additives may be non-halogenated. A wide variety of fire resistant additives may be provided, including but not limited to fiberglass, talc, calcium carbonate, powdered metals, and other minerals. Rather than contributing to a fire, the fire resistant additives may char and snuff out any combustible gasses. The sheet 100 may include lightweight material, increasing the ease of installation for users. By providing lightweight sheets, users may avoid the need for heavy equipment and labor and transportation costs may be reduced. In some embodiments, the sheet may weigh 0.2 pounds per square foot or less.

The sheet 100 may be manufactured through a wide variety of manufacturing processes. For example, in one embodiment, the sheet may be manufactured using a thermoforming approach. Materials for the sheet may be provided in a thermoplastic sheet. The thermoplastic sheet may be heated so that it may be more easily deformed. The thermoplastic sheet may be deformed using a mold so that one or more cusps 104 and/or other features may be provided in the thermoplastic sheet. Once deformation has occurred, the sheet 100 may be cooled so that it will retain its shape. Other manufacturing processes may also be used, such as injection molding, vacuum forming, etc.

This sheet 100 may include a body 102 and one or more cusps 104. The body 102 is flat in the illustrated embodiment, but the body 102 may be curved or possess a non-planar cross-sectional shape in some embodiments. The body 102 may define a front surface 106 and a rear surface 108 (see FIG. 1C), and the cusps 104 may protrude outwardly from the front surface 106. Cusps 104 may be provided at various positions on the body 102. The cusps 104 may be designed and arranged so that they have a high compressive strength while also allowing liquid water, air, and/or other fluids to flow easily through channels 110 (see, e.g., FIG. 1D) formed by the cusps 104. This may reduce the amount of mold that is formed. In some embodiments, the compressive strength of the cusps may be over 5,200 pounds per square foot, and in some embodiments, the compressive strength of the cusps may even be over 10,000 pounds per square foot.

In some embodiments, the cusps 104 may be provided in a pattern. For example, as can be seen most clearly in the embodiment illustrated in FIG. 1B, the cusps 104 may be arranged in a grid pattern with the cusps 104 aligned in separate rows and columns. However, cusps 104 may be provided in other patterns, or the cusps 104 may not be provided in a pattern at all. For example, cusps 104 may be provided only at the extreme corners of the body 102 in some embodiments.

The cusps 104 may possess a wide variety of shapes, including symmetrical and non-symmetrical shapes. In the illustrated embodiment, the cusps 104 have a circular shape, but a rectangular-shape, triangular-shape, oval shape, or some other shape may also be used. Additionally, the cusps 104 are illustrated as having a uniform shape and size in the illustrated embodiment. However, the shape and size of cusps 104 may differ in some embodiments. For example, the diameter or width of a cusp 104 may be greater in one location. Alternatively, the thickness of material may be greater at a cusp 104 than the thickness of material at other locations to increase the strength of the cusp 104.

In some embodiments, fillets and/or chamfers may be used at various edges of the cusp 104. These fillets and chamfers may assist in increasing the strength of the cusp 104. For example, in FIGS. 1A-1D, the cusps 104 include fillets at some of the edges of the cusps 104.

Additional features of the sheet 100 are best understood with reference to FIG. 1D. FIG. 1D illustrates a cross-sectional view of the sheet of FIG. 1A about the line A-A of FIG. 1B. In this figure, channels 110 and recesses 112 formed by the cusps 104 may be readily seen. Air, water, and/or other fluids may flow through the channels 110, and this may enhance drainage and prevent moisture buildup and water damage.

The sheet 100 may be provided with a wide variety of shapes, sizes and dimensions. However, exemplary dimensions are provided herein for the embodiment illustrated in FIG. 1D. The cusps 104 may possess a variety of shapes. Where a circular cusp is used similar to those illustrated in FIGS. 1A-1D, the cusps 104 may possess a maximum diameter (B) and a minimum diameter (C). The maximum diameter (B) may be approximately 0.66 inches in some embodiments, and the minimum diameter (C) may be approximately 0.44 inches in some embodiments.

The sheet 100 may also possess a thickness (D). In some embodiments, this thickness (D) may remain constant at the tapered sections of the cusps 104 and at the other flat portions of the cusps 104 and the body 102. However, in some embodiments, the thickness may differ between the body 102 and the cusps 104. For example, the thickness at the cusps 104 may be greater than the thickness at other portions of the sheet to increase the compressive force that the cusps 104 may withstand. In the illustrated embodiment, the thickness (D) is generally constant throughout the sheet, and the thickness is approximately 0.03 inches.

Cusps 104 may be offset from each other by an offset distance (E). This offset distance may deviate depending on the pattern of the cusps 104, the necessary compressive strength for the sheet, etc. In the illustrated embodiment, the cusps 104 are generally provided in a grid pattern with rows and columns, and the offset distance (E) is 0.90 inches.

The sheet 100 may have a total thickness (F). This total thickness (F) may be selected based on the necessary size of the gap between two layers, and sheets may be provided with a wide variety of total thicknesses (F). In the illustrated embodiment, the total thickness (F) is 0.31 inches.

As noted above, the cusps 104 may possess a wide variety of shapes. In some embodiments, the cusps 104 may taper inwardly from the body 102 as illustrated in FIG. 1D so that the maximum diameter (B) of the cusps 104 is provided at the body 102 and so that the minimum diameter (C) of the cusps 104 is provided away from the body 102. In the illustrated embodiment, the cusps 104 has a taper angle (G) of approximately 108 degrees. However, this taper angle may be different in other embodiments.

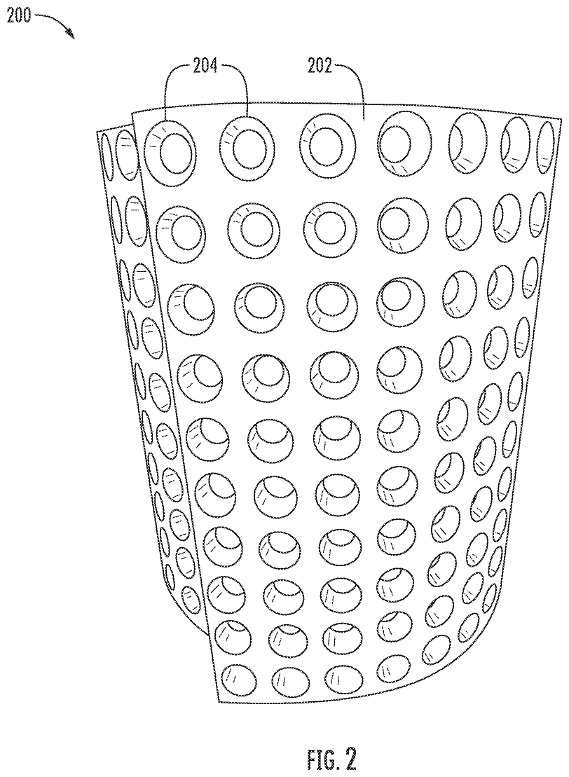

The sheet may be flexible enough to permit the sheet to be easily rolled up or folded up so that it may be stored and/or transported. FIG. 2 illustrates a perspective view of another example sheet 200. Similar to the sheet 100 of FIGS. 1A-1D, the sheet 200 may include a body 202 and one or more cusps 204. As illustrated the body 202 of the sheet 200 may be configured so that it may bend along its length, and this may permit the sheet 200 to be easily stored and/or transported.

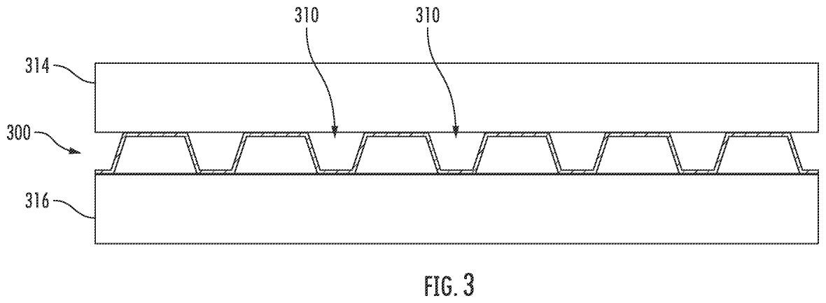

As noted above, a sheet may be provided a wide variety of components so that a gap may be maintained. FIG. 3 illustrates a schematic view of an example system with a sheet 300 maintaining a gap between two layers. In FIG. 3, a first layer 314 and a second layer 316 are illustrated, and a sheet 300 may be installed between the first layer 314 and the second layer 316. As can be seen, the sheet 300 may include cusps 304, and these cusps 304 may be similar to the other cusps 104, 204 discussed above. The cusps 304 may form one or more channels 310, and these channels 310 may permit air, water, and/or other fluids to flow through. Thus, the cusps 304 may provide an effective air gap between the first layer 314 and the second layer 316. The system illustrated in FIG. 3 may be representative of a flooring system, a ceiling system for exterior or interior walls of a building, a pedestrian/access tunnel liner, a moisture barrier, a roofing system, garden roof system, among others.

The cusps 104 and the pattern used for the cusps 104 may be configured to reduce the amount of any undesired bow, warp, and other deformation of the shape of the layers 314, 316. For example, the cusps 104 may be positioned in the grid pattern illustrated in FIGS. 1A-1C. This may provide support for both layers 314, 316 at regular intervals, minimizing any undesired bow, warp, and other deformation of the shape of the layers 314, 316.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A sheet for providing an air gap comprising:
a body defining a first surface; and
cusps;
wherein the cusps extend from the first surface of the body, wherein one or more channels are formed between the cusps, and wherein the sheet comprises a fire-resistant material.

2. The sheet of claim 1, wherein the sheet comprises a thermoplastic material.

3. The sheet of claim 1, wherein the sheet comprises at least one of fiberglass, talc, calcium carbonate, or powdered metal.

4. The sheet of claim 1, wherein the sheet is formed through at least one of thermoforming, injection molding, or vacuum forming.

5. The sheet of claim 1, wherein the sheet is configured to be placed between two layers.

6. The sheet of claim 5, wherein the sheet is configured to reduce the amount of deformation in the shape of the two layers.

7. The sheet of claim 5, wherein the cusps are provided in a pattern.

8. The sheet of claim 7, wherein the cusps are configured to provide support to the two layers at regular intervals.

9. The sheet of claim 8, wherein the cusps are provided to form a grid pattern.

10. The sheet of claim 1, wherein the cusps have a compressive strength of over 5,200 pounds per square foot.

11. The sheet of claim 1, wherein the one or more channels are configured to permit liquid water, air, and/or other fluids to flow through.

12. The sheet of claim 1, wherein the sheet weighs 0.2 pounds per square foot or less.

13. The sheet of claim 1, wherein the cusps have a first material thickness and the body has a second material thickness.

14. The sheet of claim 13, wherein the first material thickness is greater than or equal to the second material thickness.

15. The sheet of claim 1, wherein the cusps include at least one of a fillet or a chamfer.
